(19) United States
(12) Patent Application Publication
(10) Pub. No.: US 2016/0307243 A1
(43) Pub. Date: Oct. 20, 2016

(54) SYSTEMS AND METHODS FOR DETERMINING VALUATION DATA FOR A LOCATION OF INTEREST

(71) Applicant: MasterCard International Incorporated, Purchase, NY (US)

(72) Inventors: Debashis Ghosh, Charlotte, NC (US); Manash Bhattacharjee, Jersey City, NJ (US); Randy Shuken, Westport, CT (US)

(21) Appl. No.: 14/690,115

(22) Filed: Apr. 17, 2015

(51) Int. Cl. G06Q 30/02; G06F 17/30; H04W 4/02; G06Q 50/16

(52) U.S. Cl. CPC G06Q 30/0278; G06Q 50/165; G06F 17/30265; H04W 4/025

(57) ABSTRACT

A computer-implemented method for providing valuation data for a location of interest (LOI) to a user is provided. The method includes receiving, by a real estate valuation computing device, a location request message generated at a mobile device associated with the user. The location request message includes image data and mobile device data. The method also includes mapping the LOI to a physical location based at least in part on the mobile device data, and determining valuation data for the LOI based on the physical location. The valuation data includes a real estate rating for the LOI. The method further includes generating a location response message that includes at least the valuation data and the physical location of the LOI, and transmitting the location response message to the mobile device.

### BACKGROUND OF THE DISCLOSURE

This disclosure relates to determining valuation data for a real estate location, and more specifically to methods and systems for providing valuation data for a location of interest.

Valuing real estate is difficult and time-consuming. In particular, valuing commercial real estate is difficult because the valuator must not only value the physical property (i.e., the building, the location, and any improvements to the building), but may also have to value the business operating at the property or the potential business that may be located at the property.

Collecting and processing data for such a valuation is a complex process. As a result, the valuation of commercial real estate assets is often only conducted by professional appraisers, owners of the property and commercial lenders. The real estate industry would benefit from allowing consumers or other interested parties to take part in evaluating locations of interest such as commercial real estate properties. Accordingly, it is desirable to have a system that enables consumers, with limited to no appraisal experience, to quickly and easily learn the value of a location of interest such as a piece of commercial real estate.

### BRIEF DESCRIPTION OF THE DISCLOSURE

In one aspect, a computer-implemented method for providing valuation data for a location of interest (LOI) to a user using a real estate valuation (REV) computing device is provided. The REV computing device is in communication with a memory. The method includes receiving, by the REV computing device, a location request message generated at a mobile device associated with the user. The location request message includes image data and mobile device data. The image data includes an image of the LOI and an image timestamp associated with the image. The method also includes mapping, by the REV computing device, the LOI to a physical location based at least in part on the mobile device data. The method further includes determining, by the REV computing device, valuation data for the LOI based on the physical location. The valuation data includes a real estate rating for the LOI. The method also includes generating a location response message that includes at least the valuation data and the physical location of the LOI. The method still further includes transmitting the location response message to the mobile device.

In another aspect, a computer system for providing valuation data for a location of interest (LOI) to a user is provided. The computer system includes a memory and a real estate valuation computing device including a processor. The processor is configured to receive a location request message generated at a mobile device associated with the user. The location request message includes image data and mobile device data. The image data includes an image of the LOI and an image timestamp associated with the image. The processor is also configured to map the LOI to a physical location based at least in part on the mobile device data. The processor is further configured to determine valuation data for the LOI based on the physical location. The valuation data includes a real estate rating for the LOI. The processor is also configured to generate a location response message that includes at least the valuation data and the physical location of the LOI. The processor is still further configured to transmit the location response message to the mobile device.

In yet another aspect, a computer-readable storage medium having computer-executable instructions embodied thereon for providing valuation data for a location of interest (LOI) to a user is provided. When executed by a real estate valuation (REV) computing device having at least one processor, the computer-executable instructions cause the processor to receive a location request message generated at a mobile device associated with the user. The location request message includes image data and mobile device data. The image data includes an image of the LOI and an image timestamp associated with the image. The computer-executable instructions also cause the processor to map the LOI to a physical location based at least in part on the mobile device data. The computer-executable instructions further cause the processor to determine valuation data for the LOI based on the physical location. The valuation data includes a real estate rating for the LOI. The computer-executable instructions also cause the processor to generate a location response message that includes at least the valuation data and the physical location of the LOI. The computer-executable instructions still further cause the processor to transmit the location response message to the mobile device.

### BRIEF DESCRIPTION OF THE DRAWINGS

FIGS. 1-9 show example embodiments of the methods and systems described herein.

FIG. 1 is a schematic diagram illustrating an example multi-party payment card industry system for enabling payment-by-card transactions that may contribute to valuation of a location of interest (LOI) in accordance with one example embodiment of the present disclosure.

FIG. 2 is a simplified block diagram of an example embodiment of a computer system used in processing payment transactions that includes a real estate valuation (REV) computing device in accordance with one example embodiment of the present disclosure.

FIG. 3 is an expanded block diagram of an example embodiment of a computer device architecture of a system used to provide valuation data for a location of interest (LOI) as shown in FIG. 1.

FIG. 4 illustrates an example configuration of a client device as shown in FIG. 2.

FIG. 5 illustrates an example configuration of a server computing device as shown in FIG. 2.

FIG. 6 is a simplified data flow diagram for providing valuation data for a location of interest (LOI) using a real estate valuation (REV) computing device as shown in FIG. 2 in accordance with an example embodiment of the present disclosure.

FIG. 7A illustrates a first example user interface of a real estate valuation (REV) client application in accordance with one example embodiment of the present disclosure

FIG. 7B illustrate a second example user interface of a real estate valuation (REV) client application in accordance with one example embodiment of the present disclosure.

FIG. 8 is a database view of an example embodiment of REV computing device as shown in FIG. 2 in accordance with one example embodiment of the present disclosure.

FIG. 9 is a flowchart of a process for determining valuation data for a location of interest using the system shown in FIG. 2.

Like numbers in the Figures indicate the same or functionally similar components.

### DETAILED DESCRIPTION

The methods and systems described herein are directed to providing valuation data for a location of interest (LOI). The real estate service system described herein provides real estate valuation services to, for example, real estate lenders, borrowers, consumers, and merchants. The services may include providing data (“valuation data”) representing property values, income factors, revenue estimates, tax information, etc., for a location of interest. The real estate service system includes a real estate valuation (REV) computing device in communication with an application programming interface (API) platform. The API platform includes software therein for implementing a REV client application. The REV client application communicates data collected from a mobile computing device (“mobile device”) by the REV client application. The mobile device is operated by a user interested in learning the value of the LOI.

The following detailed description illustrates embodiments of the disclosure by way of example and not by way of limitation. It is contemplated that the embodiments have general application to processing valuation and financial transaction data by a third party in industrial, commercial, and residential applications.

In particular, in an example embodiment, a user accesses the REV client application on his or her mobile device. The user engages with the REV client application to capture an image of the LOI on the mobile device and to capture mobile device data (e.g., GPS data) from the mobile device. Upon request by the user, the REV client application transmits image data (e.g., the image of the LOI and an associated timestamp) and the mobile device data to the REV computing device. The REV computing device is configured to use the received image data and mobile device data to map the LOI to a physical location (e.g., a street address). The REV computing device is also configured to determine valuation data (e.g., a real estate rating) for the LOI and to transmit the physical location and the valuation data, through the API platform, to the REV client application for display to the user.

More particularly, in some embodiments, the REV client application is downloaded onto the mobile device by the user. The term “mobile device” is used herein to refer generally to any mobile computing device, such as those capable of interconnecting to the internet or equivalent networking technology, including a web-based phone, also referred to as a smart phone, personal digital assistant (PDA), tablet, or other mobile, web-based connectable equipment. If the user wishes to receive information (e.g., valuation data) about an LOI, the user selects the REV client application on the mobile device. The REV client application, with permission from the user, has access to a camera included in the mobile device. The user interacts with a user interface of the REV client application and captures an image of the LOI, using the camera, as well as a timestamp associated with the image. The image of the LOI and the associated timestamp (“image timestamp”) are collectively referred to herein as “image data.” The REV client application also has access to data collected from other components of the mobile device, including, but not limited to, an accelerometer, a compass, a gyroscope, and a GPS. Collectively, this data is referred to herein as “mobile device data.” The REV client application may collect mobile device data having a timestamp substantially equal to the image timestamp. In other words, the REV client application collects the mobile device data associated with a moment in which the image was captured.

The user further interacts with the user interface of the REV client application to select an option to transmit the image data and mobile device data. The REV client application generates a location request message that includes at least the image data and the mobile device data. The REV client application transmits the location request message through the API platform. The API platform may validate the authenticity of the location request message. The API platform further forwards the location request message, including the image data and the mobile device data, to the REV computing device. As will be described herein, the REV computing device uses the mobile device data to map the LOI to a physical location (e.g., a street address) and uses the physical location to determine valuation data for the LOI. The REV computing device generates and returns a location response message including the valuation data to the API platform for forwarding to the mobile device. The REV client application receives the location response message and configures the results for display to the user at the mobile device.

In order to determine valuation data for the LOI, the REV computing device is configured to receive information describing and/or defining the LOI. Such received information may be referred to as “real estate definitions.” In an example embodiment, a location manager (e.g., a commercial real estate owner or a commercial real estate lender) may access the REV computer device (directly or via any suitable user device) and provide real estate definitions. In another embodiment, the real estate definitions are provided to the REV computing device via third parties or third-party devices that may store such information and may be capable of communicating such real estate definitions to the REV computing device. Accordingly, the REV computing device is configured to receive real estate definitions for a plurality of LOIs from a plurality of sources, and is configured to process real estate definitions associated with the plurality of LOIs.

A “location manager” is used herein to refer generally to an entity that may input real estate definitions to the real estate service system and/or the REV computer device, update real estate definitions, and/or otherwise manage real estate definitions for one LOI or a plurality of LOIs. Location managers may be commercial real estate owners, commercial real estate lenders, or any other entity having access to information related to an LOI and/or a real estate definition. As noted above, other third parties may also provide such real estate definitions to the REV computing device.

Real estate definitions may include information associated with a LOI including property location information, property identifiers, property condition information, property layout information, property age information, property classification information (or property categorization), property ownership tenure information, property legal information, possible tenant information, past tenancy information, and current tenancy information.

Property location information may include any information defining a physical location of an LOI. The REV computing device uses the received mobile device data to associate the received image with the physical location of the LOI. The REV computing device further uses the physical location of the LOI to access and use associated real estate definitions in order to determine valuation data for the LOI. In some embodiments, property location information may include physical addresses, geographic coordinates in latitude and longitude, elevation information (e.g., a floor or floors of a building associated with the LOI), and any other suitable information. In some examples, property location information may include boundary information defining a physical area (or areas) containing the LOI. In some embodiments, property location information may also be used by the REV computing device to monitor the value of the LOI. In a first example, the REV computing device may identify a neighborhood, region, or area associated with the LOI using any suitable mapping or reference system. The REV computing device may obtain information related to the relative, subjective, or objective qualities of the neighborhood, region, or area. For example, neighborhoods, regions, or areas may be associated with average commercial real estate asset values per square foot, social media reviews or opinions, investment profiles, and other suitable data that may be used to determine quantitative or qualitative assessments of the neighborhoods, regions, or areas containing the LOI. The REV computing device may accordingly adjust the value of the LOI based on such determined assessments, as described herein. In a second example, the REV computing device may identify neighbors comparable to the LOI (“comps”) and use such comps to adjust the value of the LOI. As noted above, property location information may be provided to the REV computing device by a location manager or some other third-party data source (e.g., a third-party device) capable of providing such data to the REV computing device.

Property identifiers may include known names of an LOI (e.g., “XYZ Mall”) or any suitable unique alphanumeric identifier. In some embodiments, the REV computing device uses property identifiers to designate each LOI. The location manager may view and manage individual LOIs distinguished by identifiers such as property identifiers. As noted above, property identifiers may be provided to the REV computing device by a location manager or some other third-party data source capable of providing such data to the REV computing device.

Property condition information may include any suitable information related to the design, maintenance, and upkeep of an LOI. Property condition information may accordingly describe building materials used in the construction of the LOI, known needed repairs, repair history, and costs associated with the existing construction and needed repair. In some embodiments, the REV computing device may use property condition information to adjust the value of the LOI. As noted above, property condition information may be provided to the REV computing device by a location manager or some other third-party data source capable of providing such data to the REV computing device.

Property layout information may include any suitable description of the physical area of the LOI in any suitable units including square feet, square miles, and acres. Property layout information may also include information describing sub-divisions of the LOI. In some embodiments, LOI may include multiple divisions that may be rented, leased, sold to, or otherwise made available to commercial tenants. In such embodiments, the REV computing device may process property layout information and identify such sub-divisions of the LOI. As described below and herein, the REV computing device may accordingly use such identified sub-divisions to associate particular merchants as tenants of sub-divisions. As noted above, property layout information may be provided to the REV computing device by a location manager or some other third-party data source capable of providing such data to the REV computing device.

Property age information includes information regarding the age of the entirety or individual sections of the LOI and may also include the age of repairs or replacements made to portions or sections of the LOI. In some embodiments, the REV computing device may use property age information to adjust the value of the LOI. As noted above, property age information may be provided to the REV computing device by a location manager or some other third-party data source capable of providing such data to the REV computing device.

Property classification information includes information categorizing the LOI within categories that may be relevant to the value of the LOI. For example, property classification information may categorize an LOI as, for example, “retail”, “office”, “warehouse”, “manufacturing”, “outdoor mall”, “indoor mall” and any other suitable information. In some embodiments, the REV computing device may use property classification information to adjust the value of the LOI. As noted above, property classification information may be provided to the REV computing device by a location manager or some other third-party data source capable of providing such data to the REV computing device.

Property ownership tenure information includes information related to the history of ownership of the LOI by the current owner and by previous owners. As noted above, property ownership tenure information may be provided to the REV computing device by a location manager or some other third-party data source capable of providing such data to the REV computing device.

Property legal information includes information related to the legal aspects of the LOI. Property legal information may include, for example, taxes associated with the LOI, zoning information indicating authorized uses for the LOI, covenants on the LOI, easements on the LOI, other burdens on the LOI, previous lawsuits associated with the LOI, and insurance information related to the LOI. In some embodiments, the REV computing device may use property legal information to adjust the value of the LOI. As noted above, property legal information may be provided to the REV computing device by a location manager or some other third-party data source capable of providing such data to the REV computing device.

Possible tenant information includes information related to the possible tenant options for the LOI. Accordingly, possible tenant information may relate to property layout information (that may identify sub-divisions that may be rented by tenants). Possible tenant information may include, for example, the total number of units that may be rented or leased within the LOI. As noted above, possible tenant information may be provided to the REV computing device by a location manager or some other third-party data source capable of providing such data to the REV computing device.

Current tenancy information includes information related to the current tenants of the LOI. Accordingly, current tenancy information may include, for example, business identifiers for businesses that are renting the LOI, rental payment history for each current tenant, vacant units, and information related to the tenure of tenancy for each current tenant. Business identifiers may identify a particular merchant renting all or a portion of the LOI. In some embodiments, such a renter may be a company with multiple locations (e.g., a chain). In such embodiments, the business identifier may further identify an individual location for such a merchant. As described below, such business identifiers may be used to associate transaction data, social media data, visit data, and other suitable data with the renter. Further, business identifiers may include a reference number associated with an evaluation of the renter on an external evaluation service. Accordingly, the REV computing device may obtain and process transaction data, social media data, visit data, external evaluation data, and other data related to the renter and accordingly adjust the value of the commercial real estate. As noted above, current tenancy information may be provided to the REV computing device by a location manager or some other third-party data source capable of providing such data to the REV computing device.

Past tenancy information includes information related to the previous tenants of the LOI. Accordingly, past tenancy information may include, for example, business identifiers for businesses that previously rented the LOI, rental payment history, vacant unit history, and information related to the tenure of tenancy for each previous tenant. As noted above, past tenancy information may be provided to the REV computing device by a location manager or some other third-party data source capable of providing such data to the REV computing device.

The REV computing device processes real estate definitions and allows the location manager to verify that the real estate definitions are accurate for the LOI. Such a process may be referred to as a “Validation Phase” performed by the REV computing device. In some examples, the location manager may verify that current tenancy information (including tenant merchant information) is accurate. In other examples, the location manager may verify that property identifiers, property location information, property condition information, property layout information, property age information, property classification information (or property categorization), property ownership tenure information, property legal information, possible tenant information, past tenancy information, and current tenancy information are correctly defined in real estate definitions.

In some embodiments, the REV computing device values an LOI based on at least two factors. First, the REV computing device values the LOI based on underlying characteristics of the LOI. Such characteristics may be referred to as “property factors.” Second, the REV computing device values the LOI based on income characteristics associated with the LOI. Such characteristics may be referred to as “income factors.”

The REV computing device receives property factors associated with each LOI. The REV computing device may receive property factors from one or more location managers associated with each LOI. Property factors are related to overall characteristics of each LOI while not including characteristics related to income associated with the LOI. Property factors may include information derived based on real estate definitions, described above and herein. Property factors may include, for example and without limitation, information derived from property identifiers, property location information, property condition information, property layout information, property age information, property classification information (or property categorization), property ownership tenure information, and property legal information. In an example embodiment, property factors represent an intrinsic value of the LOI without considering income streams associated with the LOI.

The REV computing device also receives income factors associated with each LOI. The REV computing device may receive income factors from one or more location managers associated with each LOI. Income factors may relate to historic income, current income, and projected income. Accordingly, in some examples, income factors may include possible tenant information, past tenancy information, and current tenancy information. Income factors may be relevant to determining the value of a LOI because income streams are typically factored into the value of commercial real estate, generally.

The REV computing device processes income factors and property factors to determine a real estate rating for each LOI. The real estate rating represents a calculation of the current financial value of each LOI. In at least some examples, the REV computing device may factor in previous sale prices of each LOI to determine the real estate rating. In some embodiments, unique weights are identified or determined for each income factor and each property factor. Such weights are applied to each income factor and property factor to calculate the real estate rating. In at least some embodiments, the real estate rating may be a numeric score between zero and one thousand indicating the performance of LOI generally.

The determination of the real estate rating may be referred to as a “Valuation Phase” performed by the REV computing device. As indicated below, the REV computing device may re-execute the valuation phase on demand. Specifically, in some embodiments, the REV computing device may execute the valuation phase any time a location request message for an LOI is received. In some embodiments, the REV may execute the valuation phase at regular, predetermined intervals and may transmit the most recent real estate rating in response to a location request message received during such an interval.

Present real estate ratings may be stored at the REV computing device in a memory or any other suitable storage device. In some examples, historical real estate ratings may also be stored at the REV computing device. Accordingly, as described herein, the REV computing device may retrieve at least one present real estate rating (i.e., the most recent available real estate evaluation) for an LOI.

The system described herein is configured to provide valuation data associated with an LOI to a user. Accordingly, in some embodiments, the REV computing device may receive updates regarding income factors and property factors. The REV computing device may receive updates at regular intervals or may receive updates whenever a location manager associated with LOI updates the real estate definition for the LOI. In some embodiments, the REV computing device receives a plurality of forecast data (or “early warning data” or “monitoring data”). Forecast data represents information regarding an LOI that may suggest that the value of the LOI may be changing or may have changed. Forecast data may include, for example, transaction data, social media data, merchant business data, tenancy change data, and property comparison data.

In one example, the REV computing device receives forecast data including transaction data. As described above, many commercial tenants of an LOI are merchants. Generally, the ability of a merchant to make rental payments is a factor of the profitability of the merchant. Accordingly, if a merchant has changing revenue streams, the merchant may alternately be able to pay higher rents or unable to satisfy the existing rents. By receiving an identifier for a tenant merchant in real estate definitions (as described above), the REV computing device may accordingly receive information regarding such merchant revenue streams.

Accordingly, the REV computing device may be in communication with a payment processing network (i.e., an interchange network). The payment processing network gathers transaction data from cardholders (e.g., an entity using a payment card such as a credit card, a debit card, or a prepaid card). More particularly, consumers may use payments cards to pay for goods and/or services from merchants (e.g., tenants of the LOI). Cardholders will initiate payment transactions with the merchants. Transaction data associated with these transactions are received and processed over the payment processing network. The transaction data include, among other data points, data associated with the cardholder and the merchant involved in the transaction. The REV computing device is configured to process this transaction data and generate forecast data therefrom.

The example system and methods described herein are directed to valuation of real estate and, more particularly, to a networked-based computer system and method for providing valuation data for a location of interest to a user of a mobile device. The system and methods are implemented using a real estate valuation (REV) computing device in communication with a memory. The technical effect of the disclosure is achieved by performing at least one of the following steps: (i) receiving, by the REV computing device, a location request message generated at a mobile device associated with the user, the location request message including image data and mobile device data, wherein image data includes an image of the LOI and an image timestamp associated with the image, and wherein mobile device data is captured at the mobile device; (ii) mapping, by the REV computing device, the LOI to a physical location based at least in part on the mobile device data; (iii) determining, by the REV computing device, valuation data for the LOI based on the physical location, the valuation data including a real estate rating for the LOI; (iv) generating a location response message that includes at least the valuation data and the physical location of the LOI; and (v) transmitting the location response message to the mobile device.

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

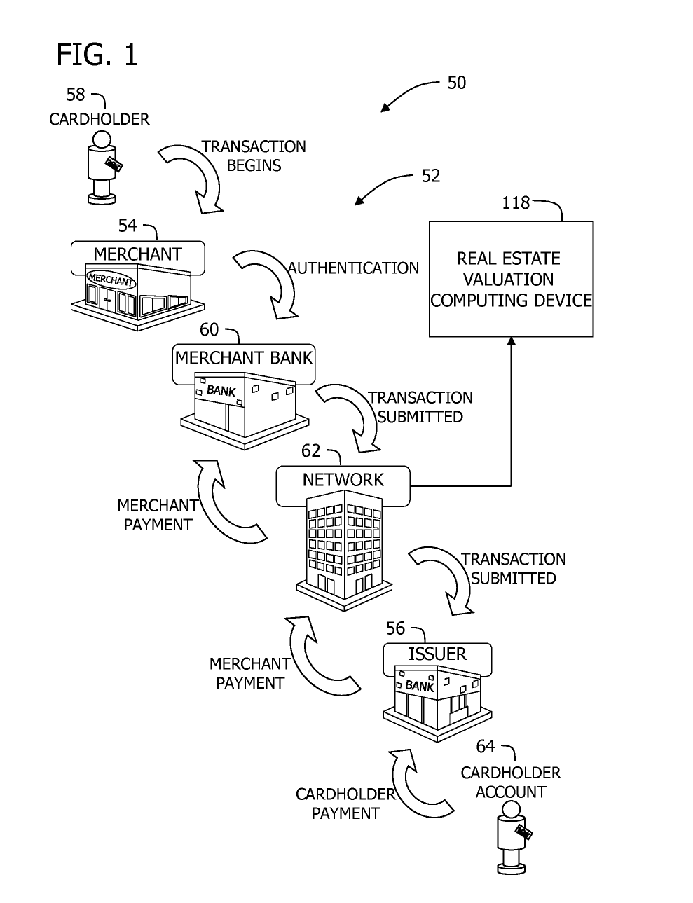

FIG. 1 is a schematic diagram 50 illustrating an example multi-party payment card industry system 52 for enabling payment-by-card transactions that may contribute to valuation of a location of interest (LOI). The methods and systems described herein relate to a payment card system, such as a credit card payment system using the MasterCard® interchange. The MasterCard® interchange is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y., U.S.A.).

Payment processing system, such as system 52, may utilize a variety of different types of payment cards offered as payment by the consumer. Payment cards can refer to, for example, credit cards, debit cards, and prepaid cards. These cards can all be used as a method of payment for performing a transaction. As described herein, the term “payment card” includes cards such as credit cards, debit cards, and prepaid cards, but also includes any other devices that may hold payment account information, such as mobile phones, personal digital assistants (PDAs), and key fobs.

In the payment card system, a financial institution called the “issuer” 56 issues a payment card, such as a credit card, to a cardholder 58, who uses the payment card to tender payment for a purchase from a merchant 54. To accept payment with the payment card, merchant 54 must normally establish an account with a financial institution that is part of the financial payment system. This financial institution is usually called the “merchant bank” 60 or the “acquiring bank” or “acquirer bank.” When cardholder 58 tenders payment for a purchase with the payment card, merchant 54 requests authorization from merchant bank 60 for the amount of the purchase. The request may be performed over telephone, but is usually performed through the use of a point-of-sale (POS) terminal (not shown in FIG. 1). The POS terminal reads the payment card identification information from, for example, a magnetic stripe on the payment card or a wireless communication device within the payment card, and communicates electronically with the transaction processing computers of merchant bank 60. Alternatively, merchant bank 60 may authorize a third party (not shown in FIG. 1) to perform transaction processing on its behalf. In this case, a POS terminal of the merchant 54 will be configured to communicate with the third party. Such a third party is usually called a “merchant processor” or an “acquiring processor.”

Using an interchange network 62, the computers of merchant bank 60 or the merchant processor will communicate with the computers of issuer bank 56 to determine whether the cardholder's account is in good standing and whether the purchase is covered by the cardholder's available credit line. Based on these determinations, the request for authorization will be declined or accepted. If the request for authorization is accepted, an authorization code is issued to merchant 54 via an authorization response message.

In the case of a credit card, when a request for authorization is accepted, the available credit line of cardholder's account 64 is decreased. Normally, a charge is not posted immediately to the cardholder's account because bankcard associations have promulgated rules that do not allow merchant 54 to charge, or “capture,” a transaction until goods are shipped or services are delivered. When merchant 54 ships or delivers the goods or services, merchant 54 captures the transaction by, for example, appropriate data entry procedures on a POS terminal. If the cardholder cancels a transaction before it is captured, a “void” is generated. If the cardholder returns goods after the transaction has been captured, a “credit” is generated.

After an electronic payment transaction is captured, the transaction is settled between merchant 54, merchant bank 60, and issuer 56. Settlement refers to the transfer of financial data or funds between a transaction account of merchant 54, merchant bank 60, and issuer 56 related to the transaction. Usually, transactions are captured and accumulated into a “batch,” which are settled as a group.

Interchange network 62 (also referred to as payment processing network 62) may be in communication with a REV computing device 118, which provides valuation data for an LOI. REV computing device 118 receives transaction data from network 62 and uses the transaction data to determine a real estate rating for the LOI. REV computing device 118 transmits the real estate rating and other valuation data for the LOI through an API platform to an REV client application. The REV client application is accessed by a user (e.g., cardholder 58) on a mobile device.

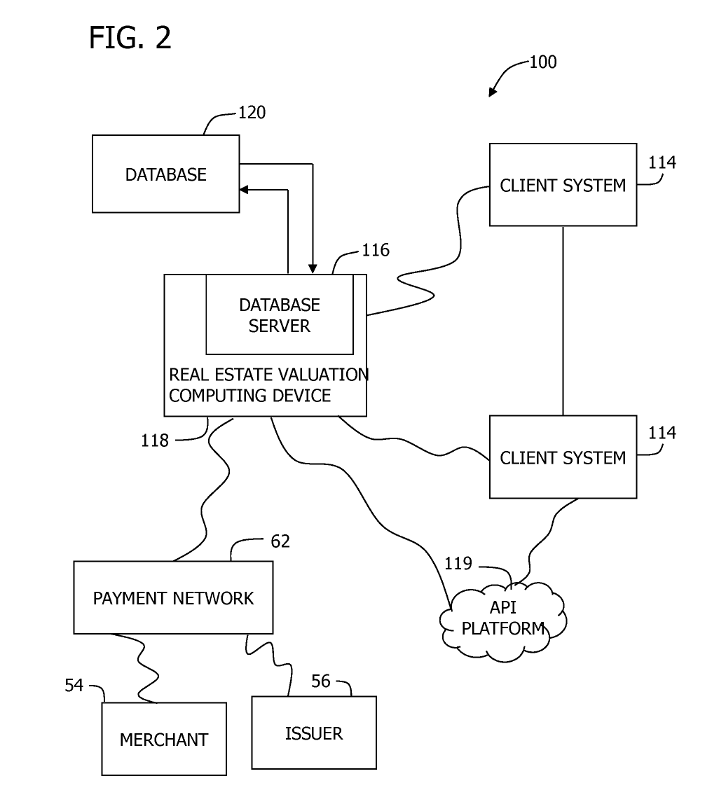

FIG. 2 is a simplified block diagram of an example embodiment of a computer system 100 used in processing payment transactions that includes real estate valuation (REV) computing device 118 in accordance with one example embodiment of the present disclosure. In the example embodiments, system 100 is used to provide valuation data for a location of interest (LOI). In the example embodiment, system 100 includes a plurality of computer devices.

More specifically, in the example embodiment, system 100 includes REV computing device 118, and a plurality of client sub-systems, also referred to as client systems 114, connected to REV computing device 118. In one embodiment, client systems 114 are computers (e.g., any mobile device) including a web browser, such that REV computing device 118 is accessible to client systems 114 using the Internet. Client systems 114 are interconnected to the Internet through many interfaces, such as a local area network (LAN) or a wide area network (WAN), dial-in-connections, cable modems, special high-speed Integrated Services Digital Network (ISDN) lines, and RDT networks. Client systems 114 may include systems associated with cardholders 68 (shown in FIG. 1) as well as external systems used to store data. REV computing device 118 is also in communication with payment network 62 (shown in FIG. 1). Further, client systems 114 may additionally communicate with payment network 62. Client systems 114 could be any device capable of interconnecting to the Internet including a web-based phone, PDA, or other web-based connectable equipment.

A database server 116 is connected to database 120, which contains information on a variety of matters, as described below in greater detail. In one embodiment, centralized database 120 is stored on REV computing device 118 and can be accessed by users (e.g., location managers or any other user) at one of client systems 114 by logging onto REV computing device 118 through one of client systems 114. In an alternative embodiment, database 120 is stored remotely from REV computing device 118 and may be non-centralized.

Database 120 may include a single database having separated sections or partitions, or may include multiple databases, each being separate from each other. Database 120 may store transaction data generated over the payment network 62 including data relating to merchants, account holders, prospective customers, issuers, acquirers, and/or purchases made. Database 120 may also store real estate definitions for a plurality of locations of interest (LOIs), including, but not limited to, property location information, property identifiers, property condition information, property layout information, property age information, property classification information (or property categorization), property ownership tenure information, property legal information, possible tenant information, past tenancy information, and current tenancy information. Database 120 may also store image data and mobile device data received from a client device 114 and associated with an LOI.

In the example embodiment, at least one of client systems 114 may be associated with a location manager, a cardholder, a user, a commercial lender, a commercial real estate owner, a real estate investor, a real estate broker, and other relevant parties. In some other embodiments, one of client systems 114 may be associated with acquirer bank 60 (shown in FIG. 1) while another one of client systems 114 may be associated with issuer bank 56 (shown in FIG. 1). In addition, client systems 114 may include a computer system associated with at least one of an online bank, a bill payment outsourcer, an acquirer bank, an acquirer processor, an issuer bank associated with a transaction card, an issuer processor, a remote payment system, customers and/or billers.

In the example embodiment, REV computing device 118 is in communication with an API platform 119, which is further in communication with client devices 114. As described herein, a user associated with a client device 114 uses a client application accessible on client device 114 to transmit a location request message through API platform 119. API platform 119 transfers the location request message to REV computing device 118. REV computing device 118 uses data from the location request message, including image data and mobile device data, to determine valuation data for a location of interest and to generate a location response message. REV computing device transmits the location response message through API platform 119, which transfers the location the response message to client device 114 for display to the user.

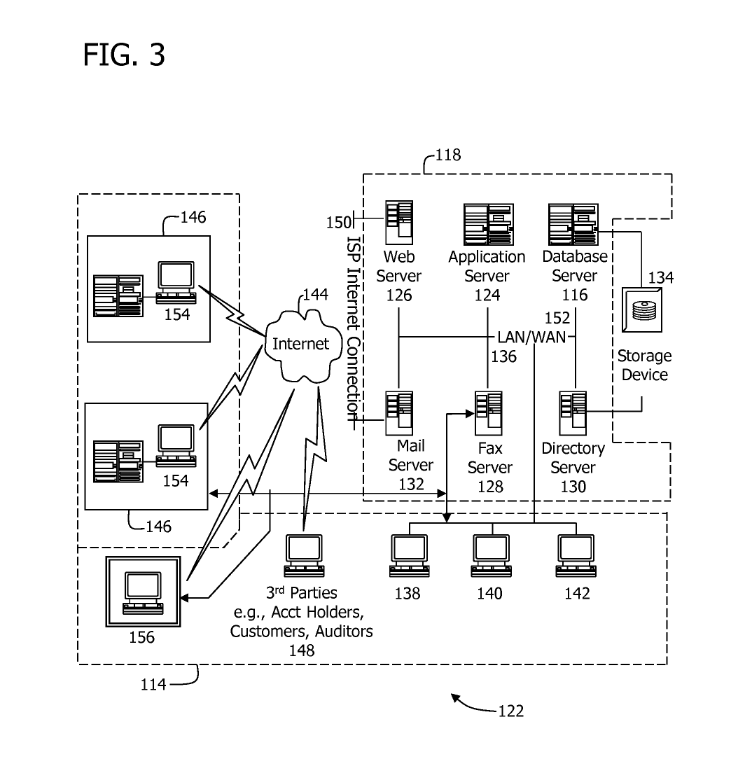

FIG. 3 is an expanded block diagram of an example embodiment of a computer device architecture of a system 122 used to provide valuation data for a location of interest (LOI) in accordance with one example embodiment of the present disclosure. Components in system 122, identical to components of system 100 (shown in FIG. 2), are identified in FIG. 3 using the same reference numerals as used in FIG. 2. System 122 includes client systems 114 and real estate valuation (REV) computing device 118. REV computing device 118 further includes database server 116, an application server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, an issuer bank workstation 138, an acquirer bank workstation 140, and a third party processor workstation 142 may be coupled to LAN 136. In the example embodiment, issuer bank workstation 138, acquirer bank workstation 140, and third party processor workstation 142 are coupled to LAN 136. Workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

REV computing device 118 is configured to be operated by various individuals including users and third parties, e.g., account holders, customers, auditors, developers, consumers, merchants, acquirers, issuers, etc., 148 using an ISP Internet connection 150. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 136, local area network 136 could be used in place of WAN 136. REV computing device 118 may include computer systems associated with locations managers, cardholders, users, commercial real estate lenders, commercial real estate owners, real estate investors, real estate brokers, and other relevant parties. System 122 may include additional computer systems associated with merchant bank 60, interchange network 62, issuer bank 56 (all shown in FIG. 1) and computer systems associated with acquirer banks and processing banks. Accordingly, system 122 is configured to communicate with REV computing device 118 and provide transaction data as discussed below.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with REV computing device 118.

Also, in the example embodiment, web server 126, application server 124, database server 116, and/or directory server 130 may host web applications, and may run on multiple server systems 118. The term “suite of applications,” as used herein, refers generally to these various web applications running on server systems 118.

Furthermore, user authentication server 128 is configured, in the example embodiment, to provide user authentication services for the suite of applications hosted by web server 126, application server 124, database server 116, and/or directory server 130. User authentication server 128 may communicate with remotely located client systems, including a client system 156. User authentication server 128 may be configured to communicate with other client systems 138, 140, and 142 as well.

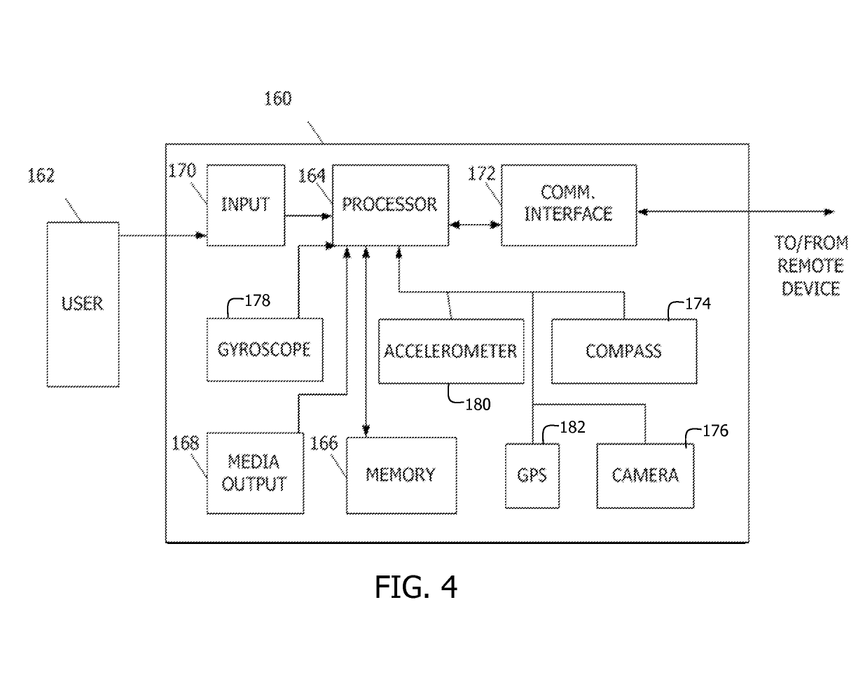

FIG. 4 illustrates an example configuration of a client device 160 operated by a user 162. Client device 160 may include any of client devices 114, any suitable mobile device, and any other computing device configured to operate as described herein. Client device 160 includes a processor 164 for executing instructions. In some embodiments, executable instructions are stored in a memory area 166. Processor 164 may include one or more processing units (e.g., in a multicore configuration). Memory area 166 is any device allowing information such as executable instructions and/or written works to be stored and retrieved. Memory area 166 may include one or more computer readable media.

Client device 160 also includes at least one media output component 168 for presenting information to user 162. Media output component 168 is any component capable of conveying information to user 162. In some embodiments, media output component 168 includes an output adapter such as a video adapter and/or an audio adapter. An output adapter is operatively coupled to processor 164 and operatively couplable to an output device such as a display device (e.g., a liquid crystal display (LCD), organic light emitting diode (OLED) display, or “electronic ink” display) or an audio output device (e.g., a speaker or headphones).

In some embodiments, client device 160 includes an input device 170 for receiving input from user 162. Input device 170 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 168 and input device 170.

Client device 160 may also include a communication interface 172, which is communicatively couplable to a remote device such real estate valuation (REV) computing device 118 (shown in FIG. 2). Communication interface 172 may include, for example, a wired or wireless network adapter or a wireless data transceiver for use with a mobile phone network (e.g., Global System for Mobile communications (GSM), 3G) or other mobile data network (e.g., Worldwide Interoperability for Microwave Access (WIMAX)).

Stored in memory area 166 are, for example, computer readable instructions for providing a user interface to user 162 via media output component 168 and, optionally, receiving and processing input from input device 170. A user interface may include, among other possibilities, a web browser and a client application. Web browsers enable users, such as user 162, to display and interact with media and other information typically embedded on a web page or a website from REV computing device 118. A client application allows user 162 to interact with a server application from REV computing device 118.

Client device 160 may also include compass 174, camera 176, and gyroscope 178. Client device 160 also includes at least one accelerometer 180. The accelerometer(s) 180 in the client device 160 may be of the common microelectromechanical (MEMS) type, having two variable capacitors formed by an arm or plate moveable between two fixed arms. Movement of the client device 160 causes movement (due to its inertia) of the moveable plate, the amount of movement (velocity and/or acceleration) being measurable by the formed capacitors. One such arrangement in each of three orthogonal directions can give all three dimensions of movement, and assess different types of movement such as roll, pitch and yaw, rotation, and the like.

Client device 160 may also include GPS 182. GPS 182 in the client device 160 includes or is in connection with the communication interface 172 and is configured to receive signals from a plurality of GPS satellites and to determine a location of the GPS 182 and the client device 160 using the signals. GPS 182 determines geopositional information for client device 160. Geopositional information may include, for example, the current latitude, longitude, and/or altitude of client device 160. The geopositional information may be calculated, for example, by communicating with GPS satellites using communication interface 172.

Client device 160 is configured to launch an REV client application by receiving input from user 160 at media input 170, which executes the REV client application on the media output 168. Client device 160 is further configured capture an image of an LOI using the REV client application, which has permission to access at least one of camera 176, processor 164, and memory 166. Further, the REV client application enables the capture of mobile device data from client device 160, wherein mobile device data includes at least accelerometer data from accelerometer 180, gyroscope data from gyroscope 178, compass data from compass 174, and GPS data from GPS 182 of client device 160 at the same moment that the image is captured.

The mobile device data collected at client device 160 is transferred with a location request message from the REV client application through API platform 119 (shown in FIG. 2) to REV computing device 118. REV computing device 118 receives mobile device data and can determine, for example, using the GPS data, a precise location of client device 160. For example, REV computing device 118 may use accelerometer data to determine the relative acceleration of user 162. REV computing device 118 may determine, for example, that user 162 is standing, walking, or in a moving vehicle. The combination of gyroscope data and compass data may enable REV computing device 118 to determine the direction in which client device 160 is pointed at the time the image of the LOI is captured at client device 160. REV computing device 118 may then determine a physical location of the LOI by comparing the mobile device data to a database containing, for example, street addresses and/or GPS components for locations (e.g., buildings) in a geographic area including the LOI. REV computing device 118 may further or alternatively access a geographic information system (GIS) that provides geographic data, including street addresses and/or GPS components, for the geographic area including the LOI. GIS data may include, for example, digital map data, the geographic location of one or more geographical features, digital elevation data, and/or digital survey data.

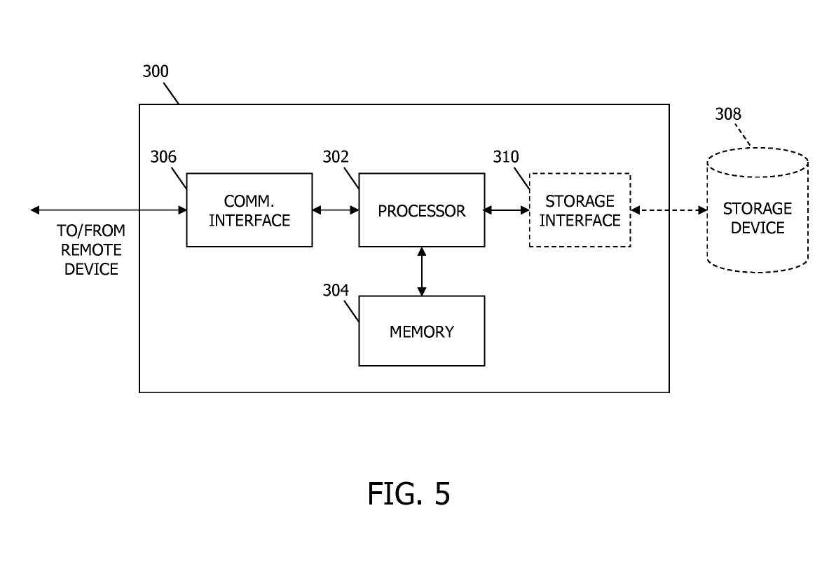

FIG. 5 illustrates an example configuration of a server computing device 300 such as REV computing device 118 (shown in FIG. 2). Server computing device 300 may also include, but is not limited to, database server 116, application server 124, web server 126, fax server 128, directory server 130, mail server 132, and any other computing device configured to function as described herein.

Server computing device 300 also includes a processor 302 for executing instructions. Instructions may be stored in a memory area 304, for example. Processor 302 may include one or more processing units (e.g., in a multicore configuration). Processor 302 is operatively coupled to a communication interface 306 such that server computing device 300 is capable of communicating with a remote device such as client device 160 (shown in FIG. 4) or another server computing device 300. For example, communication interface 306 may receive requests from client device 160 via the Internet.

Processor 302 may also be operatively coupled to storage device 308. Storage device 308 is any computer-operated hardware suitable for storing and/or retrieving data. In some embodiments, storage device 308 is integrated in server computing device 300. For example, server computing device 300 may include one or more hard disk drives as storage device 308. In other embodiments, storage device 308 is external to server computing device 300 and may be accessed by a plurality of server computing devices 300. For example, storage device 308 may include multiple storage units such as hard disks or solid state disks in a redundant array of inexpensive disks (RAID) configuration. Storage device 308 may include a storage area network (SAN) and/or a network attached storage (NAS) system.

In some embodiments, processor 302 is operatively coupled to storage device 308 via a storage interface 310. Storage interface 310 is any component capable of providing processor 302 with access to storage device 308. Storage interface 310 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 302 with access to storage device 308.

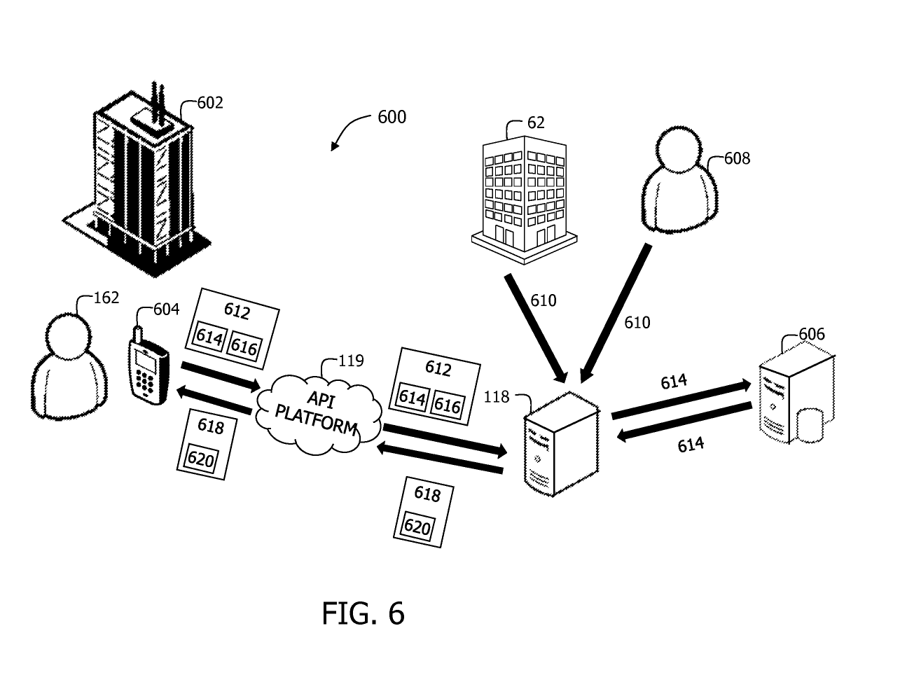

FIG. 6 is a simplified data flow diagram 600 for providing valuation data for a location of interest (LOI) 602 using a real estate valuation (REV) computing device 118 (shown in FIG. 2) in accordance with an example embodiment of the present disclosure. In general, data flows between a mobile device 604, an API platform 119 (shown in FIG. 2), REV computing device 118, an image database 606, a location manager 608, and a payment processing network 62 (shown in FIG. 1).

More particularly, in the example embodiment, REV computing device 118 may receive real estate definitions 610, as described above, associated with LOI 602 from location manager 608 and/or payment network 62. REV computing device 118 may store real estate definitions 610, including property factors, income factors, and transaction data, in a centralized or remote database (e.g., database 120, shown in FIG. 2). REV computing device 118 associates the received real estate definitions 610 with LOI 602 and/or a physical location of LOI 602.

A user 162 (shown in FIG. 4) associated with mobile device 604 accesses an REV client application (not shown) on mobile device 604. User 162 may be a location manager 608, a cardholder 58 (shown in FIG. 1), or any other person. User 162 interacts with a user interface of the REV client application to capture an image of LOI 602. The REV client application on mobile device 604 collects image data 614, including the image and associated image timestamp, and mobile device data 616. The REV client application on mobile device 604 further generates a location request message 612 including the image data 614 and the mobile device data 616. The REV client application on mobile device 604 sends location request message 612 through API platform 119.

In one example, the REV client application generates location request message 612 using an example payload message:

```
Intent imageMessageIntent=new
      Intent(android.content.Intent.ACTION_SEND);
imageMessageIntent.setType(“image/jpeg”);
File downloadedImage =new File(
      Environment.getExternalStoragePublicDirectory(
      Environment.DIRECTORY_DOWNLOADS),
      “q.jpeg”); /********q,jpeg is the temporary name of an image of
      the LOI*****/
imageMessageIntent.putExtra(Intent.EXTRA_STREAM, Uri.fromFile(
startActivity(imageMessageIntent);
```

The payload message enables the transfer of image data 614 through API platform 119. The location request message 612 also includes the mobile device data 616. The following example uses XML format language as an example, not by way of limitation:

Headers:
content-type: application/xml
content-length: {length}
Body:
<SendImage>
<Gyrometer>13147449999</Gyrometer>
<Accelerometer>X709Y719Z678</Accelerometer>
<GPS>DDLat:40.727608,Long: −74.032078</GPS>
<ImagePayload>/**Intent Image Output**/</ImagePayload>

API platform 119 transmits location request message 612 to REV computing device 118. REV computing device 118 uses mobile device data 616 from location request message 612 to map LOI 602 to a physical location. REV computing device 118 may use the physical location of LOI 602 to access real estate definitions 610 associated with LOI 602 and/or the physical location of LOI 602. REV computing device 118 determines valuation data 620 for LOI 602, valuation data 620 including at least a real estate rating. REV computing device 118 may use real estate definitions 610 to determine the real estate rating for LOI 602.

In one example, REV computing device 118 may use such language as:

<CreateMapping>
<RequestId>1244630</RequestId>
<Mapping>
<MappingId>6374</MappingId>
</Mapping>
<LocationID>2342315554</LocationID>
<Rating>569</Rating>
<TaxYOY>−1.2%</TaxYOY>
<Variance>2.5%</Variance>
<Category>Mall</Category>
<DisplayAddress>XYZ Mall</DisplayAddress>
...................................................................
..................................................................
</CreateMapping>

In this example, “RequestId” is used to label and identify location request message 612. “MappingId” is a numeric (or alphanumeric) identifier for a physical location (e.g., a street address). “LocationID” is a numeric (or alphanumeric) identifier for a location of interest. “Rating” is a real estate rating for the location of interest identified by LocationID. “TaxYOY,” “Variance,” and “Category” are examples of other valuation data determined by REV computing device 118 and included in a location response message.

In some embodiments, REV computing device 118 is configured to generate an image time series of LOI 602. A user 162 interested in learning the value of LOI 602 may be interested in knowing how LOI 602 (or the neighborhood containing LOI 602) has developed over time. REV computing device 118 can expedite this research process and make efficient the presentation of data that is often only expressed in tables of numbers and values.

Accordingly, REV computing device 118 may be in communication with image database 606. REV computing device 118 may store image data 614 associated with LOI 602 in image database 606. For example, user 162 accesses the REV client application on mobile device 604. Using the user interface of the REV client application, user 162 captures image data 614 of LOI 602. As described above, image data 614 is transferred to REV computing device 118 through API platform 119. The received image data 614 is stored in image database 606. Each stored image in the image database is associated with LOI 602 and/or the physical location of the LOI 602. REV computing device 118 may further retrieve a plurality of stored image data 614 from image database 606 to generate an image time series of LOI using stored images from the image data 614. Image timestamps from the image data 614 associated with the images enable REV computing device 118 to display the plurality of images in chronological order.

REV computing device 118 generates a location response message 618 that includes the valuation data 620 for LOI 602. Valuation data 620 may include the real estate rating and/or the image time series. REV computing device 118 sends location response message 618 through API platform 119. API platform 119 transmits location response message 618 to the REV client application on mobile device 604. The REV client application on mobile device 604 configures location response message 618 for display to user 162 on mobile device 604.

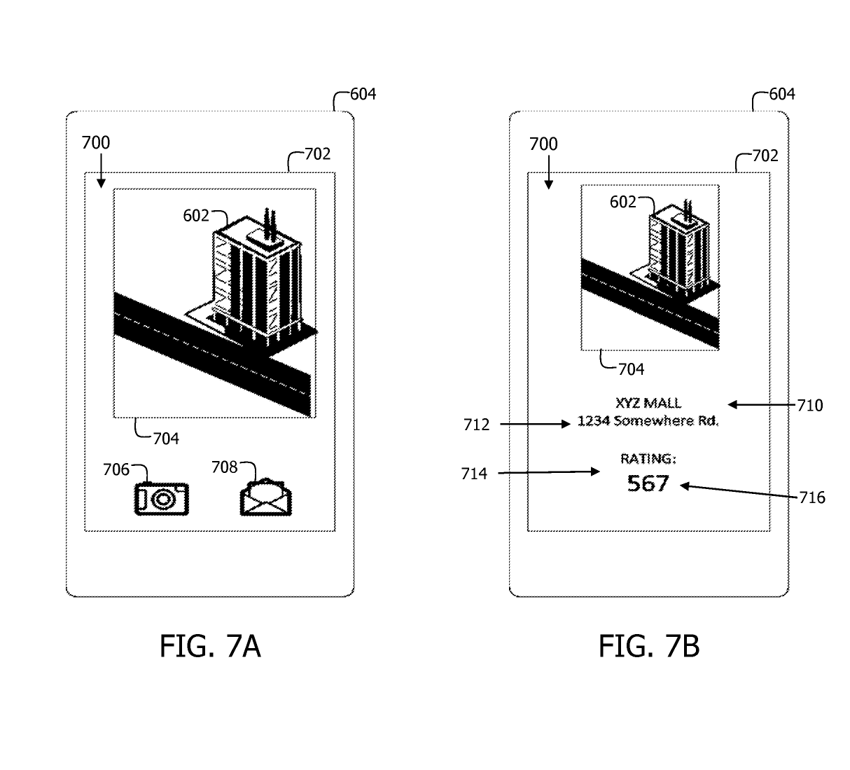

FIGS. 7A and 7B illustrate an example user interface 702 of a real estate valuation (REV) client application 700 in accordance with one example embodiment of the present disclosure. REV client application 700 is accessed by a user (e.g., user 162, shown in FIG. 4) on a mobile device 604 (shown in FIG. 6).

FIG. 7A illustrates example user interface 702 with a captured image 704 of a location of interest (LOI) 602 (shown in FIG. 6). In the example embodiment, the user has selected option 706 to capture image 704 using a camera integral to mobile device 604. The user may select option 706 to capture a new image. The user may select option 708 to send image 704 (and an associated image timestamp as well as mobile device data captured from mobile device 604). Option 708 may initiate the generation and transmission of a location request message. Alternatively, there may be one or more other options (not shown) for a user to select that separately initiate the generation of the location request message and the transmission of the location request message.

FIG. 7B illustrates example user interface 702 with image 704 as well as information received in a location response message. In the example embodiment, the location response message included property identifier 710 of LOI 602, property location information of LOI 712, and valuation data 714 for LOI 602. In the example embodiment, valuation data 714 includes real estate rating 716 for LOI 602.

Although not shown in FIGS. 7A and 7B, user interface 702 of REV client application 700 can include any number of additional commands, including, but not limited to, a “Share” command (to share the rating in an email, on a social media network, in a text message, etc.), a “Save” command (to save the property identifier and/or property location information in a “Contacts” list on the mobile device), and a “New” command (to initiate a new image capture of a new LOI). If the user is also a location manager of the LOI, there may be additional commands including, but not limited to, an “Update” command (to update real estate definitions for the LOI) and a “Record” command (to record the present real estate rating, for example, on the REV client application).

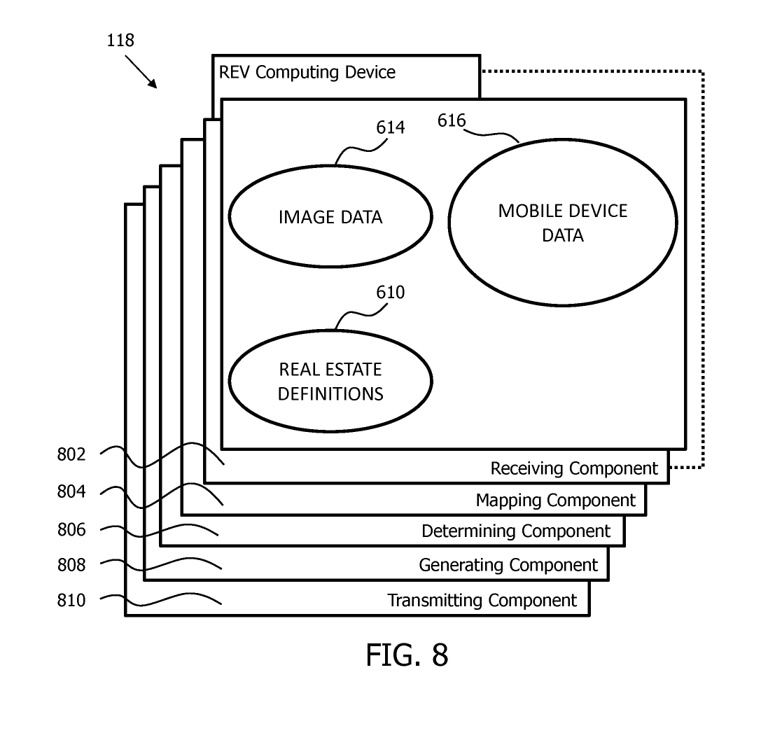

FIG. 8 is a database view of an example embodiment of REV computing device 118 in accordance with one example embodiment of the present disclosure. REV computing device 118 includes receiving component 802 for receiving a location request message for a location of interest (LOI), which includes at least image data 614 (shown in FIG. 6) associated with the LOI and mobile device data 616 (shown in FIG. 6) from a mobile device associated with a user. Receiving component 802 may also receive real estate definitions 610, including, but not limited to, property location information, property identifiers, property condition information, property layout information, property age information, property classification information (or property categorization), property ownership tenure information, property legal information, possible tenant information, past tenancy information, and current tenancy information. Receiving component may also receive forecast information, including transaction data, from a payment processing network 68 (shown FIG. 1).

REV computing device 118 further includes a mapping component 804, for mapping the LOI to a physical location based at least in part on the received mobile device data. In some embodiments, mapping component 804 of REV computing device component 118 includes geographic information systems (GIS) software or, alternatively, includes a communication link to a separate computing device that includes GIS software. REV computing device 118 may utilize GIS software to facilitate mapping the LOI to a physical location.

REV computing device 118 further includes determining component 806 for determining valuation data for the LOI based on the physical location. The valuation data may include a real estate rating. Determining component 806 may determine the real estate rating using the received real estate definitions associated with the LOI and/or the physical location of the LOI. The valuation data may further include an image time series of the LOI. REV computing device 118 may be in communication with an image database (not shown). Determining component 806 may be configured to retrieve stored image data associated with the LOI and may further be configured to generate the image time series using images from the image data based on associated image timestamps.

REV computing device 118 further includes generating component 808 for generating a location response message that includes at least the valuation data and the physical location of the LOI. REV computing devices 118 also includes transmitting component 810 for transmitting the location response message to the mobile device. Transmitting component 810 transmits the location response message through the API platform, which routes the location response message to the REV client application on the mobile device.

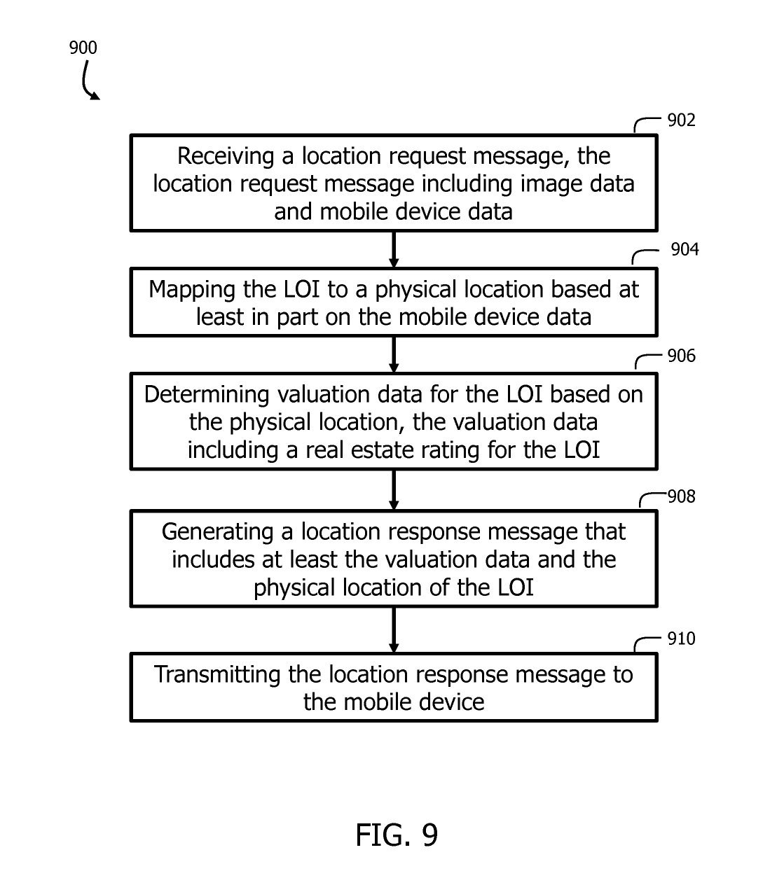

FIG. 9 is a flowchart of a process 900 for determining valuation data for a location of interest using system 100 shown in FIG. 2. In the example embodiment, process 900 is performed by REV computing device 118 (shown in FIG. 2).

REV computing device 118 receives 902 a location request message generated at a mobile device associated with the user, the location request message including image data and mobile device data. As described above, image data includes an image of the LOI and an image timestamp associated with the image, and mobile device data is captured at the mobile device. In some embodiments, REV computing device 118 receives the image data and the mobile device data through an API platform (as shown in FIG. 2).

REV computing device 118 maps 904 the LOI to a physical location based at least in part on the mobile device data. In some embodiments, REV computing device 118 may use the mapped physical location of the LOI to retrieve real estate definitions for the LOI. REV computing device 118 determines 906 valuation data for the LOI based on the physical location. In some embodiments, the valuation data is further determined based on the retrieved real estate definitions. In the example embodiment, the valuation data includes a real estate rating for the LOI. In some embodiments, the valuation data further includes an image times series, which is generated based on a plurality of stored images of the LOI. REV computing device 118 generates 908 a location response message that includes at least the valuation data and the physical location of the LOI.

REV computing device 118 transmits 910 the location response message to the mobile device. In some embodiments, REV computing device 118 transmits the location response message to the mobile device through an API platform.

This written description uses examples to disclose various embodiments, including the best mode, and also to enable any person skilled in the art to practice the disclosure, including making and using any devices or systems and performing any incorporated methods. The patentable scope of the embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for providing valuation data for a location of interest (LOI) to a user using a real estate valuation (REV) computing device in communication with a memory, the method comprising:
receiving, by the REV computing device, a location request message generated at a mobile device associated with the user, the location request message including image data and mobile device data, wherein the image data includes an image of the LOI and an image timestamp associated with the image;
mapping, by the REV computing device, the LOI to a physical location based at least in part on the mobile device data;
determining, by the REV computing device, valuation data for the LOI based on the physical location, the valuation data including a real estate rating for the LOI;
generating a location response message that includes at least the valuation data and the physical location of the LOI; and
transmitting the location response message to the mobile device.

2. The computer-implemented method of claim 1, wherein the mobile device data includes at least one of accelerometer data, compass data, gyroscope data, and GPS data captured at the mobile device having a timestamp approximately equal to the image timestamp.

3. The computer-implemented method of claim 1, wherein determining valuation data for the LOI comprises determining the real estate rating for the LOI, including:
receiving a set of property factors associated with the LOI;
receiving a set of income factors associated with the LOI including a set of transaction data associated with a tenant of the LOI, wherein the set of transaction data is received from a payment processing network;
determining a tenant revenue forecast based at least in part on the set of income factors; and
determining the real estate rating for the LOI based on the set of property factors, the set of income factors, and the tenant revenue forecast.

4. The computer-implemented method of claim 1, further comprising storing the image data in an image database, and wherein determining the valuation data further comprises:
retrieving the image data from the image database; and
generating an image time series for the LOI, wherein the image time series includes a plurality of images from the image data arranged chronologically based on image timestamps associated with respective ones of the plurality of images, and wherein the valuation data further includes the image time series.

5. The computer-implemented method of claim 1, wherein the LOI is a commercial real estate location.

6. The computer-implemented method of claim 1, further comprising causing, by the REV computing device, the valuation data to be displayed on the mobile device.

7. The computer-implemented method of claim 1, wherein transmitting the location response message comprises transmitting the location response message from the REV computing device via an application interface programming (API) platform, wherein the API platform is configured to transmit the location response message to the mobile device.

8. A computer system for providing valuation data for a location of interest (LOI) to a user, the computer system comprising:
a memory; and
a real estate valuation computing device including a processor configured to:
receive a location request message generated at a mobile device associated with the user, the location request message including image data and mobile device data, wherein the image data includes an image of the LOI and an image timestamp associated with the image;
map the LOI to a physical location based at least in part on the mobile device data;
determine valuation data for the LOI based on the physical location, the valuation data including a real estate rating for the LOI;
generate a location response message that includes at least the valuation data and the physical location of the LOI; and
transmit the location response message to the mobile device.

9. The computer system of claim 8, wherein mobile device data includes at least one of accelerometer data, compass data, gyroscope data, and GPS data captured at the mobile device having a timestamp approximately equal to the image timestamp.

10. The computer system of claim 8, wherein the processor is further configured to:
receive a set of property factors associated with the LOI;
receive a set of income factors associated with the LOI including a set of transaction data associated with a tenant of the LOI, wherein the set of transaction data is received from a payment processing network;
determine a tenant revenue forecast based at least in part on the set of income factors; and
determine the real estate rating for the LOI based on the set of property factors, the set of income factors, and the tenant revenue forecast.

11. The computer system of claim 8, wherein the processor is further configured to:
store the image data in an image database;
retrieve the image data from the image database; and
generate an image time series for the LOI, wherein the image time series includes a plurality of images from the image data arranged chronologically based on image timestamps associated with respective ones of the plurality of images, and wherein the valuation data further includes the image time series.

12. The computer system of claim 8, wherein the LOI is a commercial real estate location.

13. The computer system of claim 8, wherein the processor is further configured to cause the valuation data to be displayed on the mobile device.

14. The computer system of claim 8, wherein the real estate valuation computing device is in communication with an application interface programming (API) platform, wherein the processor is further configured to transmit the location response message via the API platform, and wherein the API platform is configured to transfer the location response message to the mobile device.

15. A computer-readable storage medium having computer-executable instructions embodied thereon for providing valuation data for a location of interest (LOI) to a user, wherein when executed by a real estate valuation (REV) computing device having at least one processor, the computer-executable instructions cause the processor to:
receive a location request message generated at a mobile device associated with the user, the location request message including image data and mobile device data, wherein the image data includes an image of the LOI and an image timestamp associated with the image;
map the LOI to a physical location based at least in part on the mobile device data;
determine valuation data for the LOI based on the physical location, the valuation data including a real estate rating for the LOI;
generate a location response message that includes at least the valuation data and the physical location of the LOI; and
transmit the location response message to the mobile device.

16. The computer-readable storage medium of claim 15, wherein mobile device data includes accelerometer data, compass data, gyroscope data, and GPS data captured at the mobile device having a timestamp approximately equal to the image timestamp.

17. The computer-readable storage medium of claim 15, wherein the computer-readable instructions further cause the processor to:
receive a set of property factors associated with the LOI;
receive a set of income factors associated with the LOI including a set of transaction data associated with a tenant of the LOI, wherein the set of transaction data is received from a payment processing network;
determine a tenant revenue forecast based at least in part on the set of income factors; and
determine the real estate rating for the LOI based on the set of property factors, the set of income factors, and the tenant revenue forecast.

18. The computer-readable storage medium of claim 15, wherein the computer-readable instructions further cause the processor to:
store the image data in an image database;
retrieve the image data from the image database; and
generate an image time series for the LOI, wherein the image time series includes a plurality of images from the image data arranged chronologically based on image timestamps associated with respective ones of the plurality of images, and wherein the valuation data further includes the image time series.

19. The computer-readable storage medium of claim 15, wherein the computer-readable instructions further cause the processor to cause the valuation data to be displayed on the mobile device.

20. The computer-readable storage medium of claim 15, wherein the computer-readable instructions further cause the processor to transmit the location response message via an application interface programming (API) platform, wherein the API platform is configured to transfer the location response message to the mobile device.
